(19) United States
(12) Patent Application Publication
(10) Pub. No.: US 2014/0327605 A1
(43) Pub. Date: Nov. 6, 2014

(54) IMAGE DEVICE

(71) Applicant: VP ASSETS LIMITED, Hong Kong (CN)

(72) Inventors: Gia Chuong PHAN, Hong Kong (CN); Hon Wah WONG, Hong Kong (CN)

(21) Appl. No.: 14/331,726

(22) Filed: Jul. 15, 2014

Related U.S. Application Data
(63) Continuation-in-part of application No. 13/526,159, filed on Jun. 18, 2012, now Pat. No. 8,803,767.
Application No. 13/526,159 is a continuation-in-part of application No. 12/906,619, filed on Oct. 18, 2010, now Pat. No. 8,717,255.

(51) Int. Cl. G09G 5/02

(52) U.S. Cl. CPC G09G 5/02; G09G 2320/0666; G09G 2300/0452
USPC 345/55

(57) ABSTRACT

The present invention is to provide an image device. The image device includes a plurality of sections. Each section includes a first pixel group, a second pixel group, a third pixel group and a fourth pixel group. The first pixel group comprises at least one first color dot and a second color dot, the second pixel group comprises at least one third color dot and the second color dot, the third pixel group comprises at least one fourth color dot and the second color dot, the fourth pixel group comprises at least one fifth color dot or the second color dot. Any four adjacent the first pixel group, the second pixel group, the third pixel group and the fourth pixel group arranged in a 2×2 matrix result in an unbalanced white.

### CROSS-REFERENCE TO RELATED APPLICATIONS

This application is a Continuation-in-Part application of co-pending U.S. application Ser. No. 13/526,159 filed Jun. 18, 2012 which was a Continuation-in-Part application of U.S. application Ser. No. 12/906,619 filed Oct. 18, 2010, now U.S. Pat. No. 8,717,255 B2 issued May 6, 2014, and for which priority is claimed under 35 U.S.C. §120. The entire contents of the above-identified applications are hereby incorporated by reference.

### BACKGROUND OF THE INVENTION

1. Field of the Invention

The invention relates to an image device.

2. Description of the Related Art

The conventional RGB stripe display 10 comprises a plurality of RGB pixel groups 11 and 12. The RGB pixel group 11 includes a red dot (R1) 111, a green dot (G1) 112 and a blue dot (B1) 113 arranged in a row direction, and the RGB pixel group 12 includes a red dot (R2) 121, a green dot (G2) 122 and a blue dot (B2) 123 arranged next to the RGB pixel group 11 in the row direction.

Since the area of the color dot is fixed and the colors of the color dot are fixed, it is hard to adjust to reach a white balance for the conventional RGB pixel group. Therefore, there is a need for an image display to solve the above problems.

### SUMMARY OF THE INVENTION

The present invention is to provide an image device. The image device includes a plurality of sections. Each section includes a plurality of pixel groups arranged in a first predetermined identical matrix form, and each pixel group includes a plurality of dots arranged in a second predetermined identical matrix form. Each section includes a first pixel group, a second pixel group, a third pixel group and a fourth pixel group. The first pixel group comprises at least one first color dot and a second color dot, the second pixel group comprises at least one third color dot and the second color dot, the third pixel group comprises at least one fourth color dot and the second color dot, the fourth pixel group comprises at least one fifth color dot or the second color dot. Any four adjacent the first pixel group, the second pixel group, the third pixel group and the fourth pixel group arranged in a 2×2 matrix result in an unbalanced white.

### BRIEF DESCRIPTION OF THE DRAWING

Further advantageous measures are described in the dependent claims. The invention is shown in the attached drawing and is described hereinafter in greater detail.

FIG. 1 shows the image device according to a first embodiment of the invention;

FIG. 2 shows the image device according to a second embodiment of the invention;

FIG. 3 shows the image device according to a third embodiment of the invention;

FIG. 4 shows the image device according to a fourth embodiment of the invention;

FIG. 5 shows the image device according to a fifth embodiment of the invention;

FIG. 6 shows the image device according to a sixth embodiment of the invention;

FIG. 7 shows the image device according to a seventh embodiment of the invention;

FIG. 8 shows the image device according to an eighth embodiment of the invention;

FIG. 9 shows the image device according to a ninth embodiment of the invention;

FIG. 10 shows the image device according to a tenth embodiment of the invention;

FIG. 11 shows the image device according to an eleventh embodiment of the invention;

FIG. 12 shows the image device according to a twelfth embodiment of the invention;

FIG. 13 shows the image device according to a thirteenth embodiment of the invention;

FIG. 14 shows the image device according to a fourteenth embodiment of the invention;

FIG. 15 shows the image device according to a fifteenth embodiment of the invention;

FIG. 16 shows the image device according to a sixteenth embodiment of the invention;

FIG. 17 shows the image device according to a seventeenth embodiment of the invention;

FIG. 18 shows the image device according to a eighteenth embodiment of the invention;

### DETAILED DESCRIPTION OF THE INVENTION

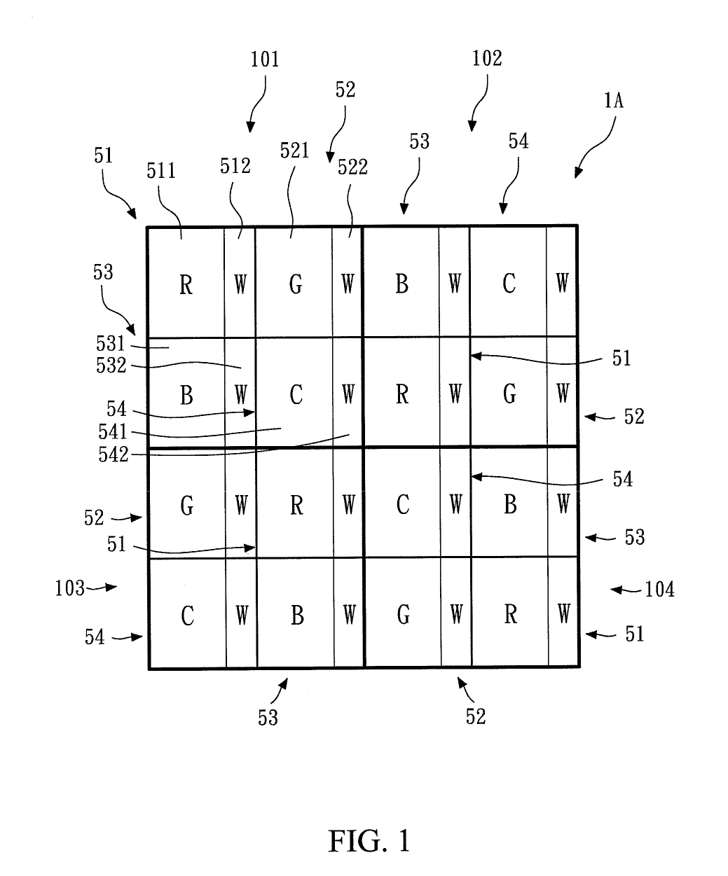

Referring to FIG. 1, it shows the image device according to a first embodiment of the invention. The image device includes a plurality of first blocks 1A. Each first block 1A includes a first section 101, a second section 102, a third section 103 and a fourth section 104 arranged in a 2×2 matrix. The first section 101 is disposed on a first column and first row position of the first block 1A, the second section 102 is disposed on a second column and first row position of the first block 1A, the third section 103 is disposed on a first column and second row position of the first block 1A, and the fourth section 104 is disposed on a second column and second row position of the first block 1A.

Each of the first section 101, the second section 102, the third section 103 and the fourth section 104 includes a plurality of pixel groups arranged in a first predetermined identical matrix form, for example, in this embodiment, the first section 101 includes four pixel groups 51, 52, 53 and 54 arranged in a 2×2 matrix. The first section 101 includes a first pixel group 51, a second pixel group 52, a third pixel group 53 and a fourth pixel group 54.

Each pixel group includes a plurality of dots arranged in a second predetermined identical matrix form, for example, in this embodiment, the pixel group includes two color dots arranged in a 2×1 matrix. The first pixel group 51 comprises one first color dot (R) 511 and one second color dot (W) 512, an area of the first color dot (R) 511 is bigger than that of the second color dot (W) 512. The second pixel group 52 comprises one third color dot (G) 521 and one second color dot (W) 522, an area of the third color dot (G) 521 is bigger than that of the second color dot (W) 522. The third pixel group 53 comprises one fourth color dot (B) 531 and one second color dot (W) 532, an area of the fourth color dot (B) 531 is bigger than that of the second color dot (W) 532. The fourth pixel group 54 comprises one fifth color dot (C) 541 and one second color dot (W) 542, an area of the fifth color dot (C) 541 is bigger than that of the second color dot (W) 542. The area of the first pixel group 51 is the same as that of the conventional RGB pixel group. In this embodiment, the first color dot (R) 511 is a red color dot, the second color dot (W) 512 is a white color dot, the third color dot (G) 521 is a green color dot, the fourth color dot (B) 531 is a blue color dot and the fifth color dot (C) 541 is a cyan color dot.

Each of the first section 101, the second section 102, the third section 103 and the fourth section 104 comprises the first pixel group 51, the second pixel group 52, the third pixel group 53 and the fourth pixel group 54. In the first section 101, the first pixel group 51 is disposed on a first column and first row position of the first section 101, the second pixel group 52 is disposed on a second column and first row position of the first section 101, the third pixel group 53 is disposed on a first column and second row position of the first section 101, the fourth pixel group 54 is disposed on a second column and second row position of the first section 101.

In the second section 102, the third pixel group 53 is disposed on a first column and first row position of the second section 102, the fourth pixel group 54 is disposed on a second column and first row position of the second section 102, the first pixel group 51 is disposed on a first column and second row position of the second section 102, the second pixel group 52 is disposed on a second column and second row position of the second section 102.

In the third section 103, the second pixel group 52 is disposed on a first column and first row position of the third section 103, the first pixel group 51 is disposed on a second column and first row position of the third section 103, the fourth pixel group 54 is disposed on a first column and second row position of the third section 103, the third pixel group 53 is disposed on a second column and second row position of the third section 103.

In the fourth section 104, the fourth pixel group 54 is disposed on a first column and first row position of the fourth section 104, the third pixel group 53 is disposed on a second column and first row position of the fourth section 104, the second pixel group 52 is disposed on a first column and second row position of the fourth section 104, the first pixel group 51 is disposed on a second column and second row position of the fourth section 104.

In the first section 101, the second section 102, the third section 103 and the fourth section 104, the first pixel group 51, the second pixel group 52, the third pixel group 53 and the fourth pixel group 54 result in an unbalanced white. This provides an advantage to reduce the color fringes of the images. When displaying saturated colors such as R, G, B, C, the subpixels luminance can be turned on to the maximum such as 255 in 8-bit color to achieve brighter image. Black and white lines can be formed in rows and columns of the image device of the invention.

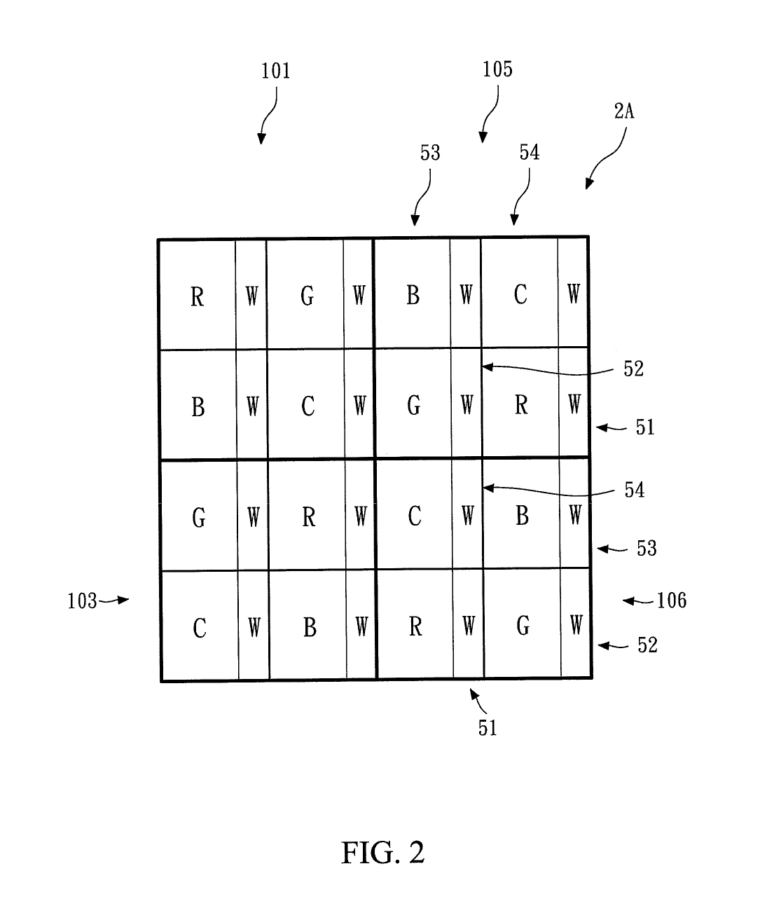

Referring to FIG. 2, it shows the image device according to a second embodiment of the invention. The image device comprises a plurality of second blocks 2A. Each second block 2A comprises the first section 101, the third section 103, a fifth section 105 and a sixth section 106. The first section 101 is disposed on a first column and first row position of the second block 2A, the fifth section 105 is disposed on a second column and first row position of the second block 2A, the third section 103 is disposed on a first column and second row position of the second block 2A, the sixth section 106 is disposed on a second column and second row position of the second block 2A.

Each of the first section 101, the third section 103, the fifth section 105 and the sixth section 106 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101 and the third section 103 in the second embodiment is the same as that in the first embodiment.

In the fifth section 105, the third pixel group 53 is disposed on a first column and first row position of the fifth section 105, the fourth pixel group 54 is disposed on a second column and first row position of the fifth section 105, the second pixel group 52 is disposed on a first column and second row position of the fifth section 105, the first pixel group 51 is disposed on a second column and second row position of the fifth section 105.

In the sixth section 106, the fourth pixel group 54 is disposed on a first column and first row position of the sixth section 106, the third pixel group 53 is disposed on a second column and first row position of the sixth section 106, the first pixel group 51 is disposed on a first column and second row position of the sixth section 106, the second pixel group 52 is disposed on a second column and second row position of the sixth section 106.

In the first section 101, the third section 103, the fifth section 105 and the sixth section 106, the first pixel group 51, the second pixel group 52, the third pixel group 53 and the fourth pixel group 54 result in an unbalanced white.

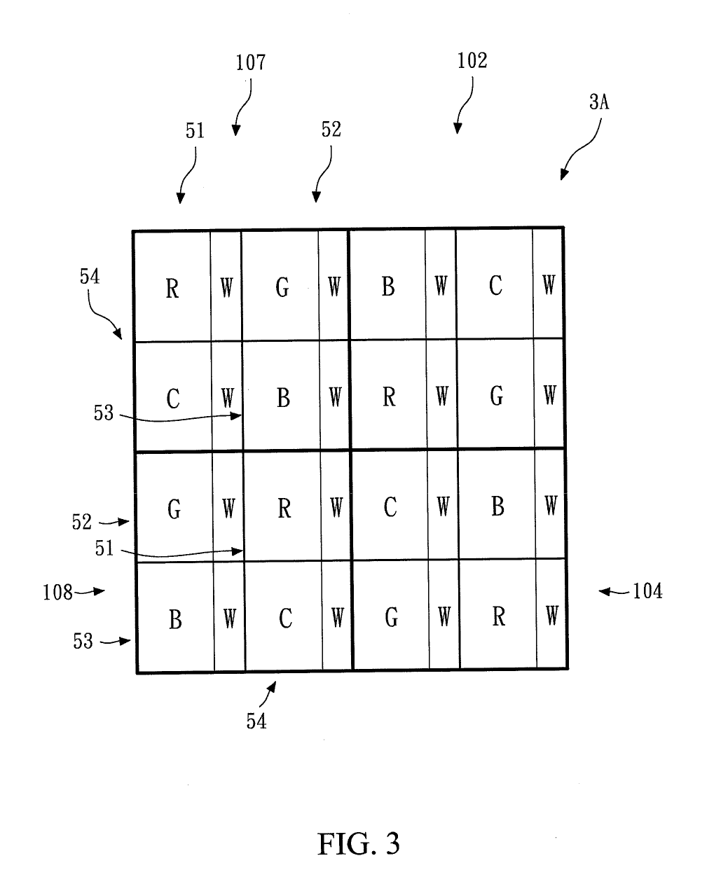

Referring to FIG. 3, it shows the image device according to a third embodiment of the invention. The image device comprises a plurality of third blocks 3A. Each third block 3A comprises the second section 102, the fourth section 104, a seventh section 107 and an eighth section 108. The seventh section 107 is disposed on a first column and first row position of the third block 3A, the second section 102 is disposed on a second column and first row position of the third block 3A, the eighth section 108 is disposed on a first column and second row position of the third block 3A, the fourth section 104 is disposed on a second column and second row position of the third block 3A.

Each of the second section 102, the fourth section 104, the seventh section 107 and the eighth section 108 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the second section 102 and the fourth section 104 in the third embodiment is the same as that in the first embodiment.

In the seventh section 107, the first pixel group 51 is disposed on a first column and first row position of the seventh section 107, the second pixel group 52 is disposed on a second column and first row position of the seventh section 107, the fourth pixel group 54 is disposed on a first column and second row position of the seventh section 107, the third pixel group 53 is disposed on a second column and second row position of the seventh section 107.

In the eighth section 108, the second pixel group 52 is disposed on a first column and first row position of the eighth section 108, the first pixel group 51 is disposed on a second column and first row position of the eighth section 108, the third pixel group 53 is disposed on a first column and second row position of the eighth section 108, the fourth pixel group 54 is disposed on a second column and second row position of the eighth section 108.

In the second section 102, the fourth section 104, the seventh section 107 and the eighth section 108, the first pixel group 51, the second pixel group 52, the third pixel group 53 and the fourth pixel group 54 result in an unbalanced white.

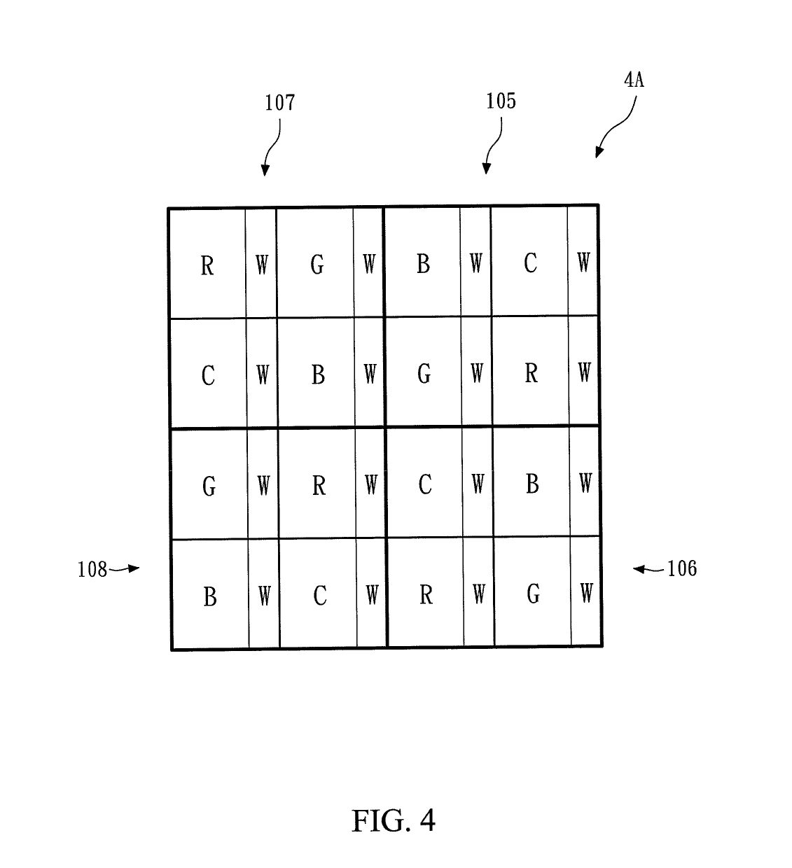

Referring to FIG. 4, it shows the image device according to a fourth embodiment of the invention. The image device comprises a plurality of fourth blocks 4A. Each fourth block 4A comprises the fifth section 105, the sixth section 106, the seventh section 107 and the eighth section 108. The seventh section 107 is disposed on a first column and first row position of the fourth block 4A, the fifth section 105 is disposed on a second column and first row position of the fourth block 4A, the eighth section 108 is disposed on a first column and second row position of the fourth block 4A, the sixth section 106 is disposed on a second column and second row position of the fourth block 4A.

Each of the fifth section 105, the sixth section 106, the seventh section 107 and the eighth section 108 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the fifth section 105, the sixth section 106, the seventh section 107 and the eighth section 108 in the fourth embodiment is the same as that in the above embodiments.

In the fifth section 105, the sixth section 106, the seventh section 107 and the eighth section 108, the first pixel group 51, the second pixel group 52, the third pixel group 53 and the fourth pixel group 54 result in an unbalanced white.

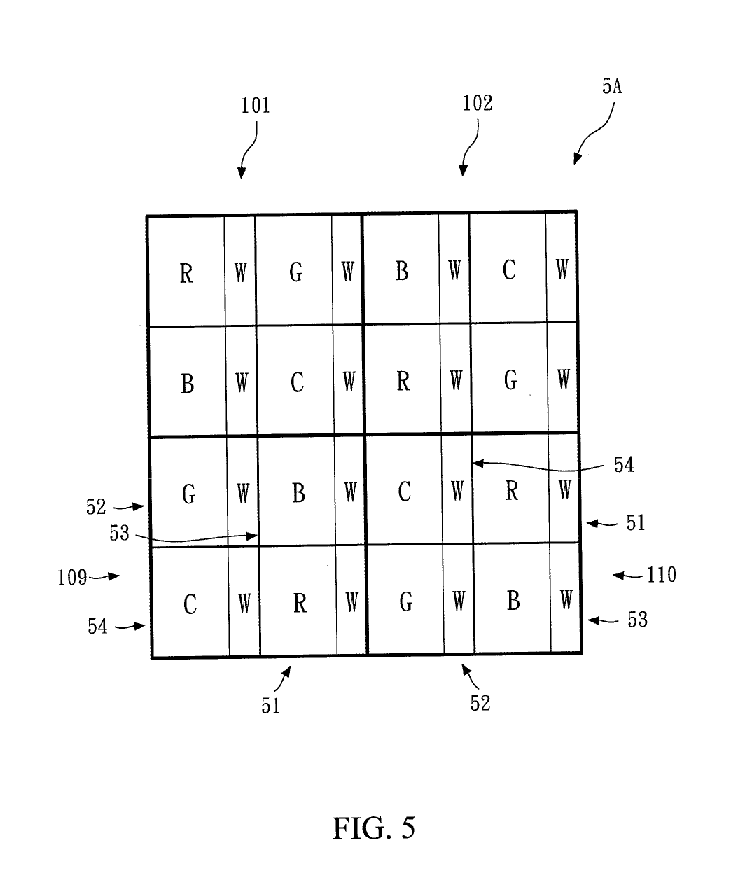

Referring to FIG. 5, it shows the image device according to a fifth embodiment of the invention. Each fifth block 5A comprises the first section 101, the second section 102, a ninth section 109 and a tenth section 110. The first section 101 is disposed on a first column and first row position of the fifth block 5A, the second section 102 is disposed on a second column and first row position of the fifth block 5A, the ninth section 109 is disposed on a first column and second row position of the fifth block 5A, the tenth section 110 is disposed on a second column and second row position of the fifth block 5A.

Each of the first section 101, the second section 102, the ninth section 109 and the tenth section 110 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101 and the second section 102 in the fifth embodiment is the same as that in the first embodiment.

In the ninth section 109, the second pixel group 52 is disposed on a first column and first row position of the ninth section 109, the third pixel group 53 is disposed on a second column and first row position of the ninth section 109, the fourth pixel group 54 is disposed on a first column and second row position of the ninth section 109, the first pixel group 51 is disposed on a second column and second row position of the ninth section 109.

In the tenth section 110, the fourth pixel group 54 is disposed on a first column and first row position of the tenth section 110, the first pixel group 51 is disposed on a second column and first row position of the tenth section 110, the second pixel group 52 is disposed on a first column and second row position of the tenth section 110, the third pixel group 53 is disposed on a second column and second row position of the tenth section 110.

In the first section 101, the second section 102, the ninth section 109 and the tenth section 110, the first pixel group 51, the second pixel group 52, the third pixel group 53 and the fourth pixel group 54 result in an unbalanced white.

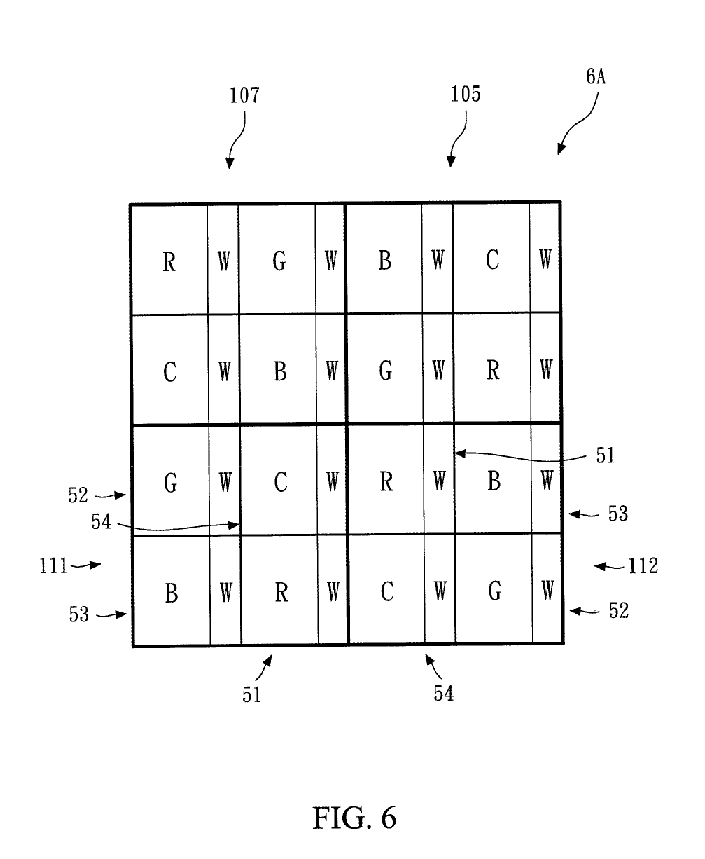

Referring to FIG. 6, it shows the image device according to a sixth embodiment of the invention. The image device comprises a plurality of sixth blocks 6A. Each sixth block 6A comprises the fifth section 105, the seventh section 107, an eleventh section 111 and a twelfth section 112. The seventh section 107 is disposed on a first column and first row position of the sixth block 6A, the fifth section 105 is disposed on a second column and first row position of the sixth block 6A, the eleventh section 111 is disposed on a first column and second row position of the sixth block 6A, the twelfth section 112 is disposed on a second column and second row position of the sixth block 6A.

Each of the fifth section 105, the seventh section 107, the eleventh section 111 and the twelfth section 112 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the fifth section 105 and the seventh section 107 in the sixth embodiment is the same as that in the above embodiments.

In the eleventh section 111, the second pixel group 52 is disposed on a first column and first row position of the eleventh section 111, the fourth pixel group 54 is disposed on a second column and first row position of the eleventh section 111, the third pixel group 53 is disposed on a first column and second row position of the eleventh section 111, the first pixel group 51 is disposed on a second column and second row position of the eleventh section 111.

In the twelfth section 112, the first pixel group 51 is disposed on a first column and first row position of the twelfth section 112, the third pixel group 53 is disposed on a second column and first row position of the twelfth section 112, the fourth pixel group 54 is disposed on a first column and second row position of the twelfth section 112, the second pixel group 52 is disposed on a second column and second row position of the twelfth section 112.

In the fifth section 105, the seventh section 107, the eleventh section 111 and the twelfth section 112, the first pixel group 51, the second pixel group 52, the third pixel group 53 and the fourth pixel group 54 result in an unbalanced white.

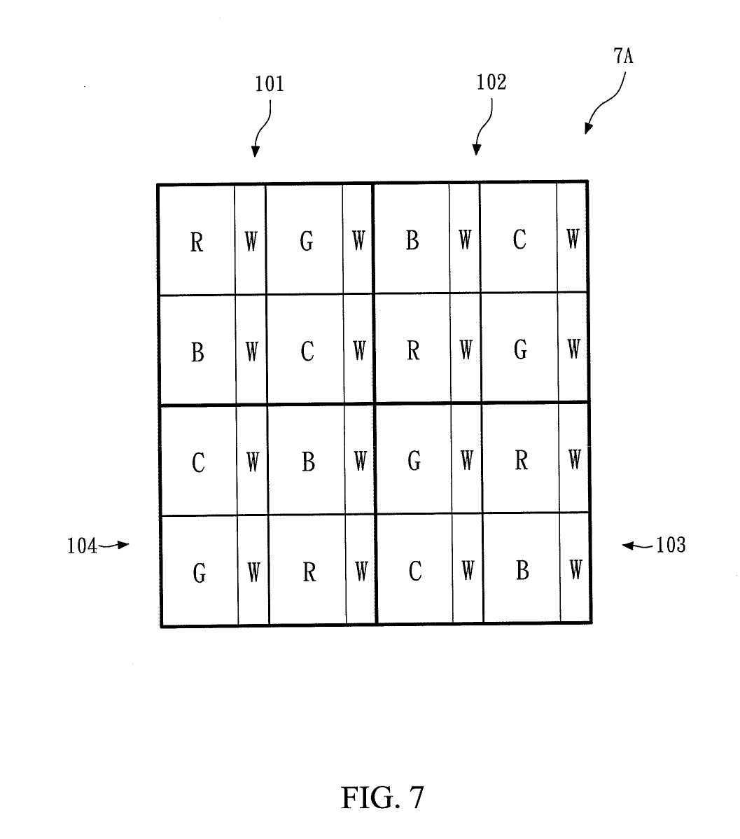

Referring to FIG. 7, it shows the image device according to a seventh embodiment of the invention. The image device comprises a plurality of seventh blocks 7A. Each seventh block 7A comprises the first section 101, the second section 102, the third section 103 and the fourth section 104. The first section 101 is disposed on a first column and first row position of the seventh block 7A, the second section 102 is disposed on a second column and first row position of the seventh block 7A, the fourth section 104 is disposed on a first column and second row position of the seventh block 7A, the third section 103 is disposed on a second column and second row position of the seventh block 7A.

Each of the first section 101, the second section 102, the third section 103 and the fourth section 104 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101, the second section 102, the third section 103 and the fourth section 104 in the seventh embodiment is the same as that in the first embodiment.

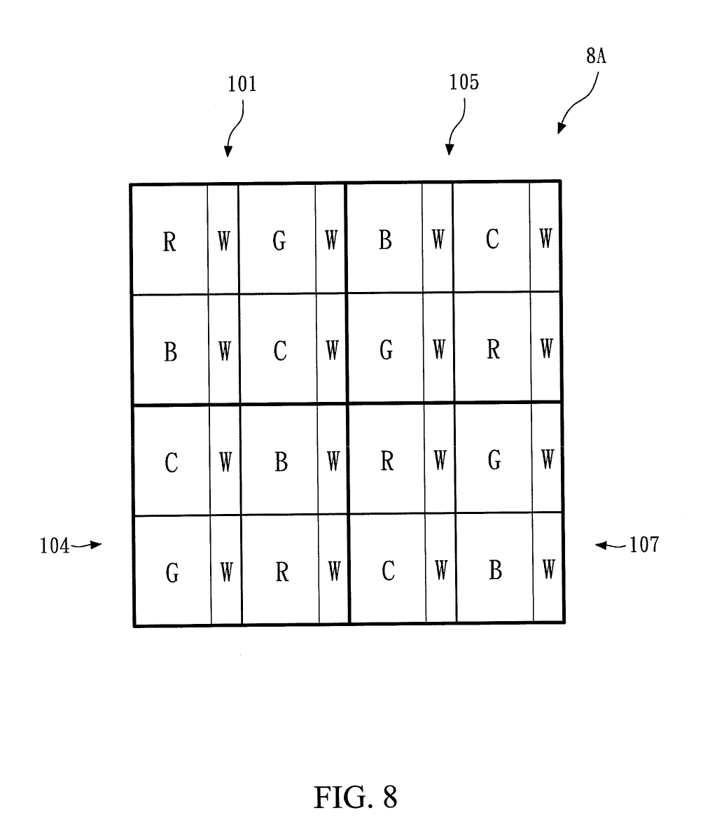

Referring to FIG. 8, it shows the image device according to an eighth embodiment of the invention. The image device comprises a plurality of eighth blocks 8A. Each eighth block 8A comprises the first section 101, the fourth section 104, the fifth section 105 and the seventh section 107. The first section 101 is disposed on a first column and first row position of the eighth block 8A, the fifth section 105 is disposed on a second column and first row position of the eighth block 8A, the fourth section 104 is disposed on a first column and second row position of the eighth block 8A, the seventh section 107 is disposed on a second column and second row position of the eighth block 8A.

Each of the first section 101, the fourth section 104, the fifth section 105 and the seventh section 107 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101, the fourth section 104, the fifth section 105 and the seventh section 107 in the eighth embodiment is the same as that in the above embodiments.

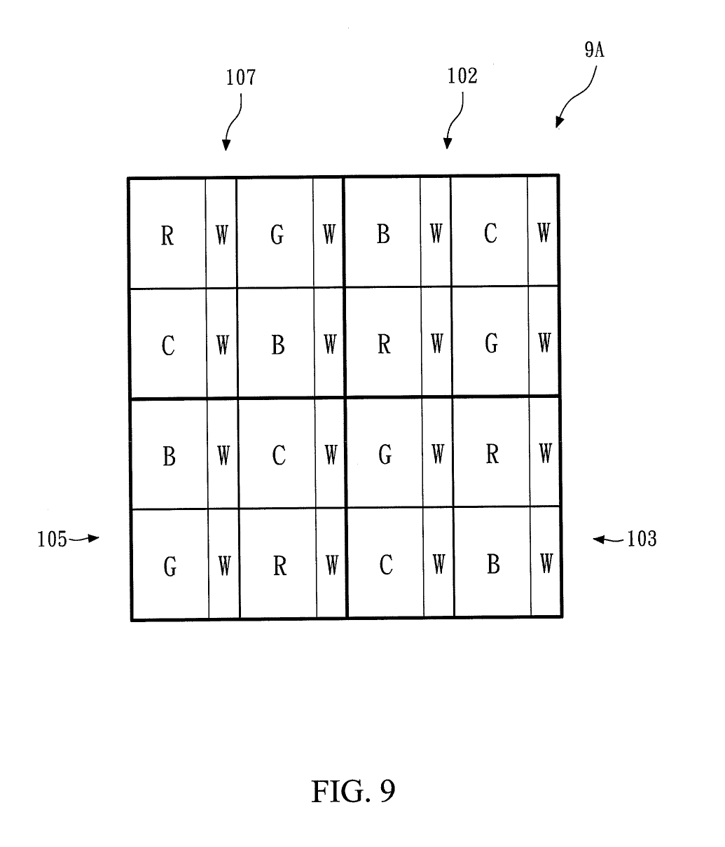

Referring to FIG. 9, it shows the image device according to a ninth embodiment of the invention. The image device comprises a plurality of ninth blocks 9A. Each ninth block 9A comprises the second section 102, the third section 103, the fifth section 105 and the seventh section 107. The seventh section 107 is disposed on a first column and first row position of the ninth block 9A, the second section 102 is disposed on a second column and first row position of the ninth block 9A, the fifth section 105 is disposed on a first column and second row position of the ninth block 9A, the third section 103 is disposed on a second column and second row position of the ninth block 9A.

Each of the second section 102, the third section 103, the fifth section 105 and the seventh section 107 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the second section 102, the third section 103, the fifth section 105 and the seventh section 107 in the ninth embodiment is the same as that in the above embodiments.

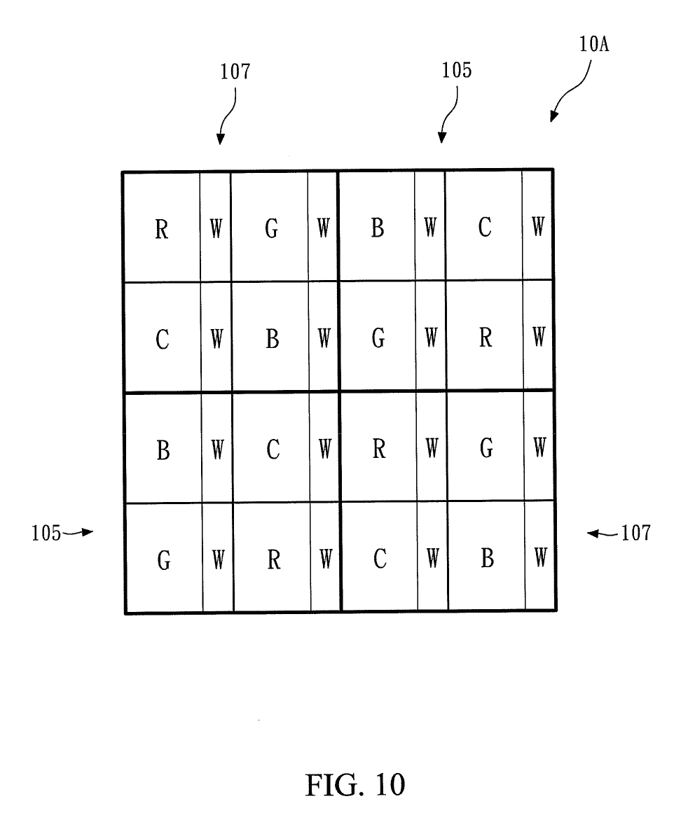

Referring to FIG. 10, it shows the image device according to a tenth embodiment of the invention. The image device comprises a plurality of tenth blocks 10A. Each tenth block 10A comprises two fifth sections 105 and two seventh sections 107. The seventh section 107 is disposed on a first column and first row position of the tenth block 10A, the fifth section 105 is disposed on a second column and first row position of the tenth block 10A, the fifth section 105 is disposed on a first column and second row position of the tenth block 10A, the seventh section 107 is disposed on a second column and second row position of the tenth block 10A.

Each of the fifth section 105 and the seventh section 107 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the fifth section 105 and the seventh section 107 in the tenth embodiment is the same as that in the above embodiments.

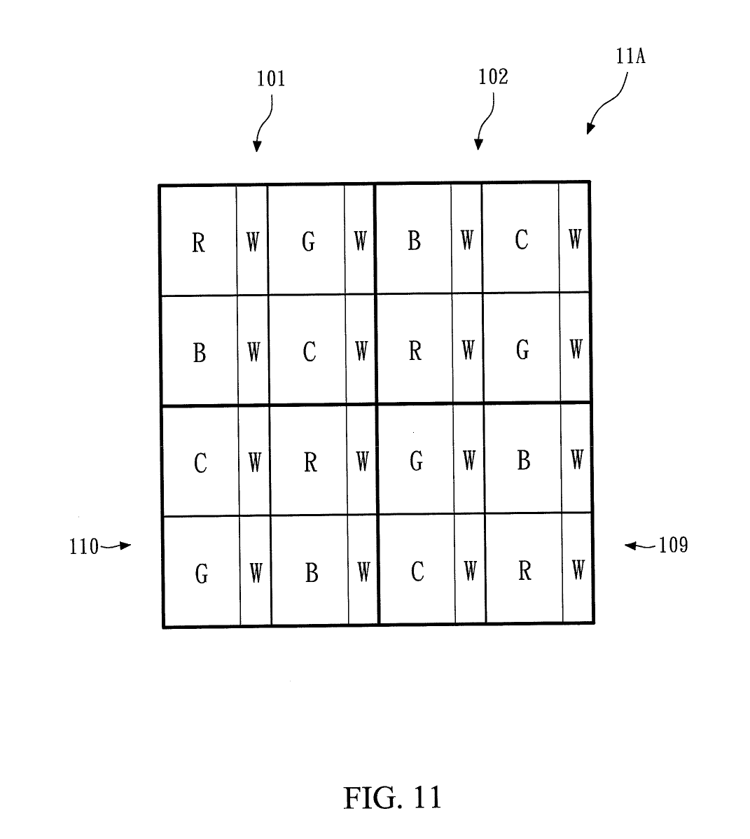

Referring to FIG. 11, it shows the image device according to an eleventh embodiment of the invention. The image device comprises a plurality of eleventh blocks 11A. Each eleventh block 11A comprises the first section 101, the second section 102, the ninth section 109 and the tenth section 110. The first section 101 is disposed on a first column and first row position of the eleventh block 11A, the second section 102 is disposed on a second column and first row position of the eleventh block 11A, the tenth section 110 is disposed on a first column and second row position of the eleventh block 11A, the ninth section 109 is disposed on a second column and second row position of the eleventh block 11A.

Each of the first section 101, the second section 102, the ninth section 109 and the tenth section 110 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101, the second section 102, the ninth section 109 and the tenth section 110 in the eleventh embodiment is the same as that in the above embodiments.

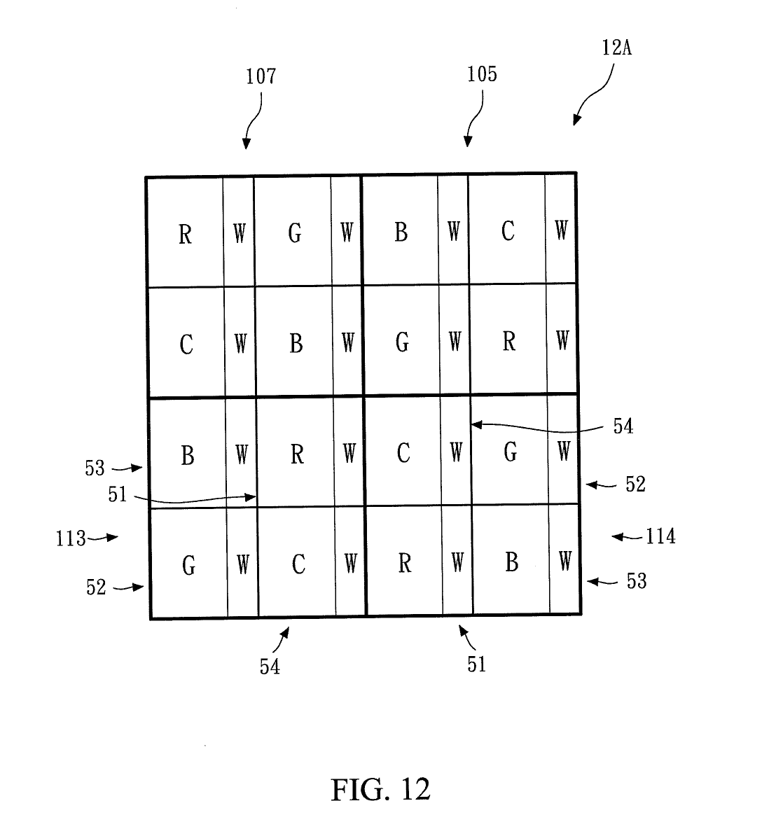

Referring to FIG. 12, it shows the image device according to a twelfth embodiment of the invention. The image device comprises a plurality of twelfth blocks 12A. Each twelfth block 12A comprises the fifth section 105, the seventh section 107, a thirteenth section 113 and a fourteenth section 114. The seventh section 107 is disposed on a first column and first row position of the twelfth block 12A, the fifth section 105 is disposed on a second column and first row position of the twelfth block 12A, the thirteenth section 113 is disposed on a first column and second row position of the twelfth block 12A, the fourteenth section 114 is disposed on a second column and second row position of the twelfth block 12A.

Each of the fifth section 105, the seventh section 107, the thirteenth section 113 and the fourteenth section 114 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the fifth section 105 and the seventh section 107 in the twelfth embodiment is the same as that in the above embodiment.

In the thirteenth section 113, the third pixel group 53 is disposed on a first column and first row position of the thirteenth section 113, the first pixel group 51 is disposed on a second column and first row position of the thirteenth section 113, the second pixel group 52 is disposed on a first column and second row position of the thirteenth section 113, the fourth pixel group 54 is disposed on a second column and second row position of the thirteenth section 113.

In the fourteenth section 114, the fourth pixel group 54 is disposed on a first column and first row position of the fourteenth section 114, the second pixel group 52 is disposed on a second column and first row position of the fourteenth section 114, the first pixel group 51 is disposed on a first column and second row position of the fourteenth section 114, the third pixel group 53 is disposed on a second column and second row position of the fourteenth section 114.

In the thirteenth section 113 and the fourteenth section 114, the first pixel group 51, the second pixel group 52, the third pixel group 53 and the fourth pixel group 54 result in an unbalanced white.

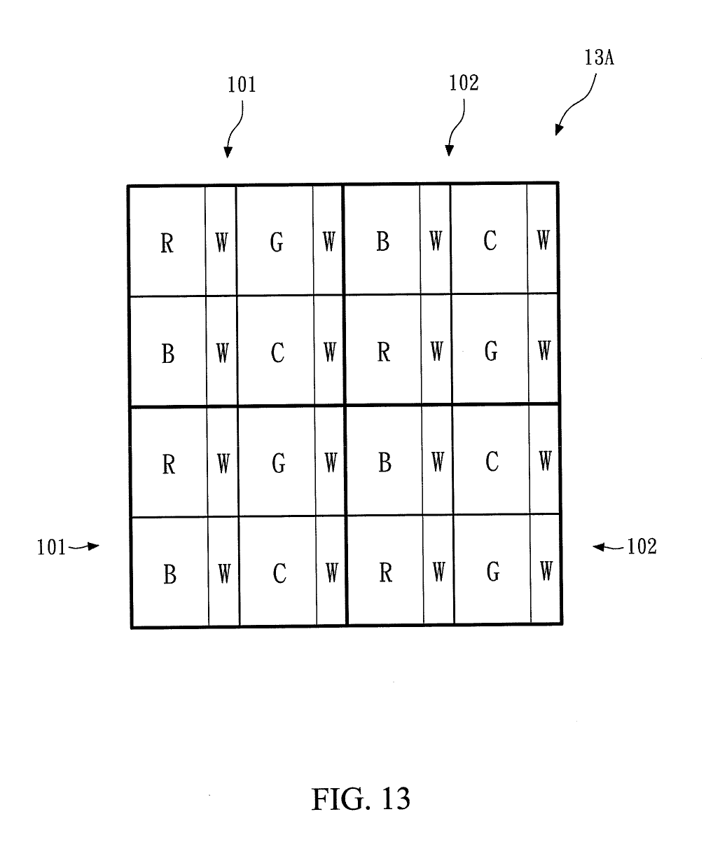

Referring to FIG. 13, it shows the image device according to a thirteenth embodiment of the invention. The image device comprises a plurality of thirteenth blocks 13A. Each thirteenth block 13A comprises two first sections 101 and two second sections 102. The first section 101 is disposed on a first column and first row position of the thirteenth block 13A, the second section 102 is disposed on a second column and first row position of the thirteenth block 13A, the first section 101 is disposed on a first column and second row position of the thirteenth block 13A, the second section 102 is disposed on a second column and second row position of the thirteenth block 13A.

Each of the first section 101 and the second section 102 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the first section 101 and the second section 102 in the second embodiment is the same as that in the first embodiment.

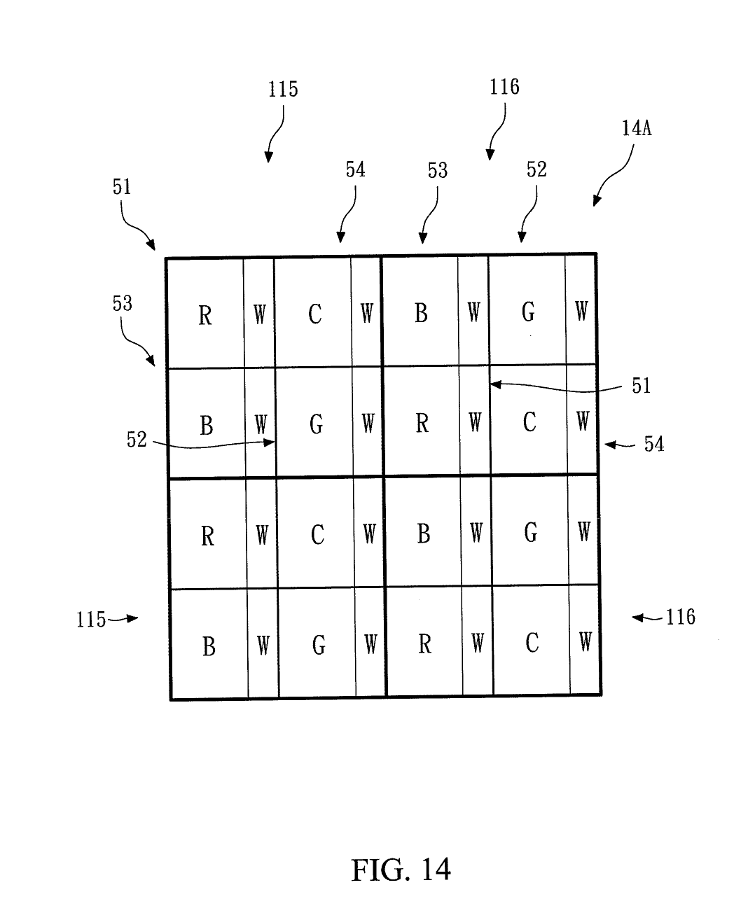

Referring to FIG. 14, it shows the image device according to a fourteenth embodiment of the invention. The image device comprises a plurality of fourteenth blocks 14A. Each fourteenth block 14A comprises two fifteenth sections 115 and two sixteenth sections 116. The fifteenth section 115 is disposed on a first column and first row position of the fourteenth block 14A, the sixteenth section 116 is disposed on a second column and first row position of the fourteenth block 14A, the fifteenth section 115 is disposed on a first column and second row position of the fourteenth block 14A, the sixteenth section 116 is disposed on a second column and second row position of the fourteenth block 14A.

Each of the fifteenth section 115 and the sixteenth section 116 comprises the first pixel group 51, the second pixel group 52, the third pixel group 53 and the fourth pixel group 54. In the fifteenth section 115, the first pixel group 51 is disposed on a first column and first row position of the fifteenth section 115, the fourth pixel group 54 is disposed on a second column and first row position of the fifteenth section 115, the third pixel group 53 is disposed on a first column and second row position of the fifteenth section 115, the second pixel group 52 is disposed on a second column and second row position of the fifteenth section 115.

In the sixteenth section 116, the third pixel group 53 is disposed on a first column and first row position of the sixteenth section 116, the second pixel group 52 is disposed on a second column and first row position of the sixteenth section 116, the first pixel group 51 is disposed on a first column and second row position of the sixteenth section 116, the fourth pixel group 54 is disposed on a second column and second row position of the sixteenth section 116.

In the fifteenth section 115 and the sixteenth section 116, the first pixel group 51, the second pixel group 52, the third pixel group 53 and the fourth pixel group 54 result in an unbalanced white.

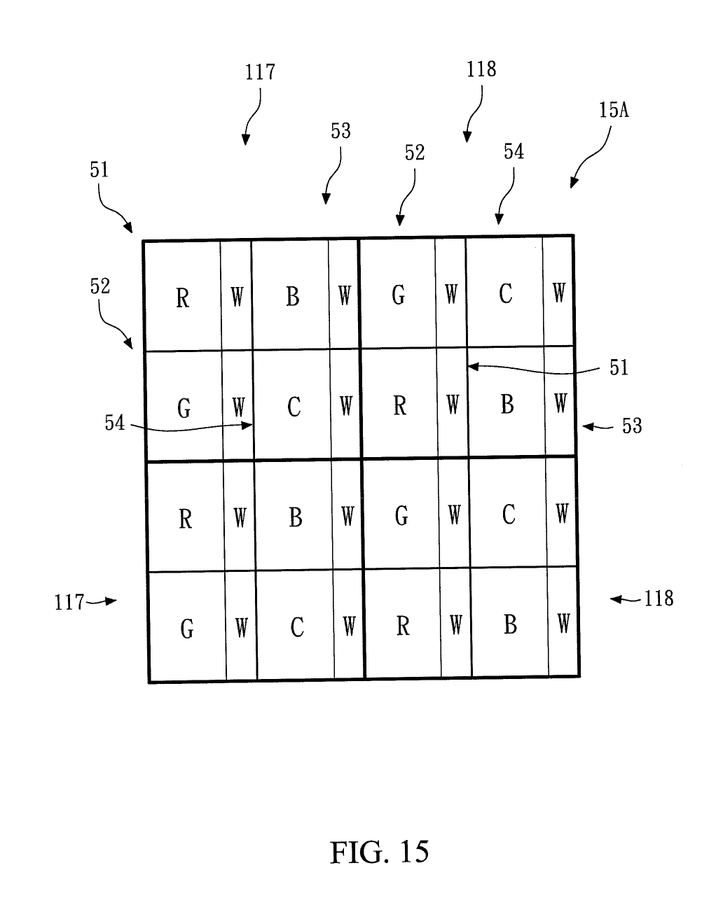

Referring to FIG. 15, it shows the image device according to a fifteenth embodiment of the invention. The image device comprises a plurality of fifteenth blocks 15A. Each fifteenth block 15A comprises two seventeenth sections 117 and two eighteenth sections 118. The seventeenth section 117 is disposed on a first column and first row position of the fifteenth block 15A, the eighteenth section 118 is disposed on a second column and first row position of the fifteenth block 15A, the seventeenth section 117 is disposed on a first column and second row position of the fifteenth block 15A, the eighteenth section 118 is disposed on a second column and second row position of the fifteenth block 15A.

Each of the seventeenth section 117 and the eighteenth section 118 comprises the first pixel group 51, the second pixel group 52, the third pixel group 53 and the fourth pixel group 54. In the seventeenth section 117, the first pixel group 51 is disposed on a first column and first row position of the seventeenth section 117, the third pixel group 53 is disposed on a second column and first row position of the seventeenth section 117, the second pixel group 52 is disposed on a first column and second row position of the seventeenth section 117, the fourth pixel group 54 is disposed on a second column and second row position of the seventeenth section 117.

In the eighteenth section 118, the second pixel group 52 is disposed on a first column and first row position of the eighteenth section 118, the fourth pixel group 54 is disposed on a second column and first row position of the eighteenth section 118, the first pixel group 51 is disposed on a first column and second row position of the eighteenth section 118, the third pixel group 53 is disposed on a second column and second row position of the eighteenth section 118.

In the seventeenth section 117 and the eighteenth section 118, the first pixel group 51, the second pixel group 52, the third pixel group 53 and the fourth pixel group 54 result in an unbalanced white.

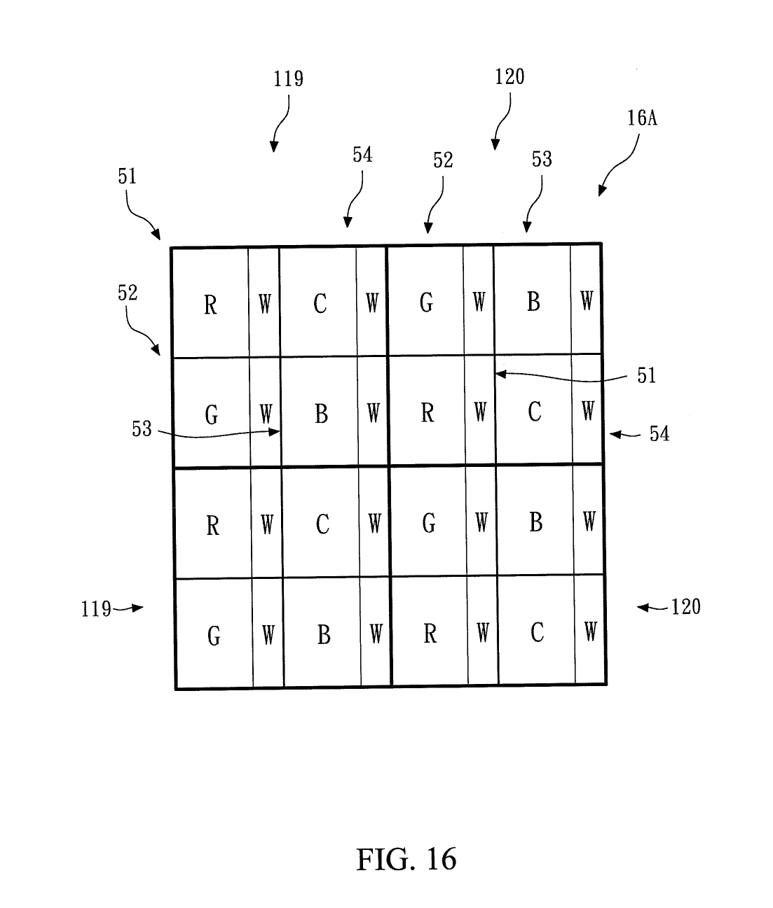

Referring to FIG. 16, it shows the image device according to a sixteenth embodiment of the invention. The image device comprises a plurality of sixteenth blocks 16A. Each sixteenth block 16A comprises two nineteenth sections 119 and two twentieth sections 120. The nineteenth section 119 is disposed on a first column and first row position of the sixteenth block 16A, the twentieth section 120 is disposed on a second column and first row position of the sixteenth block 16A, the nineteenth section 119 is disposed on a first column and second row position of the sixteenth block 16A, the twentieth section 120 is disposed on a second column and second row position of the sixteenth block 16A.

Each of the nineteenth section 119 and the twentieth section 120 comprises the first pixel group 51, the second pixel group 52, the third pixel group 53 and the fourth pixel group 54. In the nineteenth section 119, the first pixel group 51 is disposed on a first column and first row position of the nineteenth section 119, the fourth pixel group 54 is disposed on a second column and first row position of the nineteenth section 119, the second pixel group 52 is disposed on a first column and second row position of the nineteenth section 119, the third pixel group 53 is disposed on a second column and second row position of the nineteenth section 119.

In the twentieth section 120, the second pixel group 52 is disposed on a first column and first row position of the twentieth section 120, the third pixel group 53 is disposed on a second column and first row position of the twentieth section 120, the first pixel group 51 is disposed on a first column and second row position of the twentieth section 120, the fourth pixel group 54 is disposed on a second column and second row position of the twentieth section 120.

In the nineteenth section 119 and the twentieth section 120, the first pixel group 51, the second pixel group 52, the third pixel group 53 and the fourth pixel group 54 result in an unbalanced white.

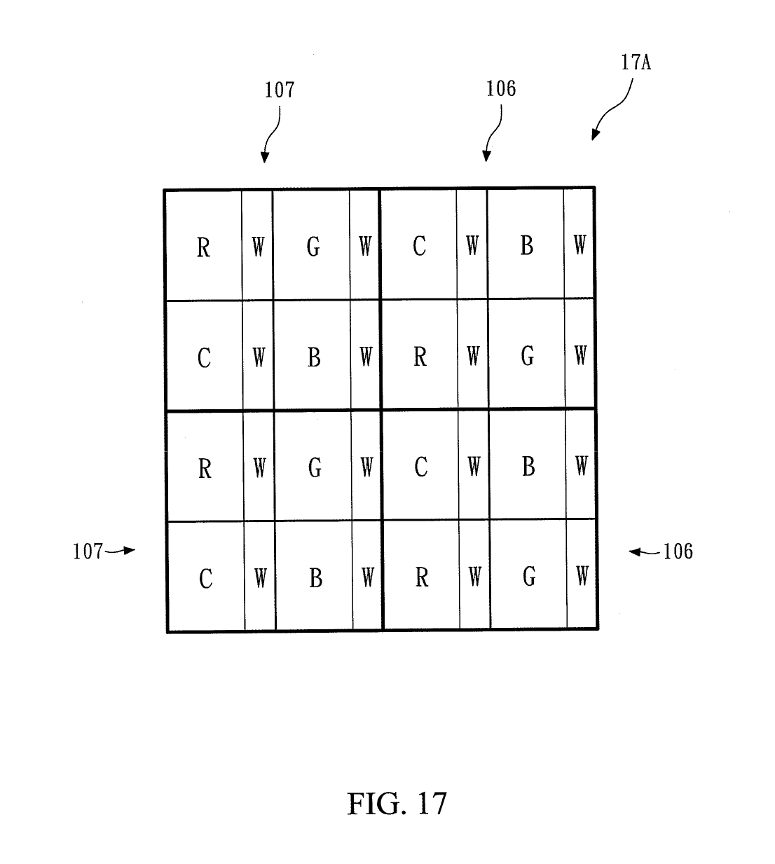

Referring to FIG. 17, it shows the image device according to a seventeenth embodiment of the invention. The image device comprises a plurality of seventeenth blocks 17A. Each seventeenth block 17A comprises two sixth sections 106 and two seventh sections 107. The seventh section 107 is disposed on a first column and first row position of the seventeenth block 17A, the sixth section 106 is disposed on a second column and first row position of the seventeenth block 17A, the seventh section 107 is disposed on a first column and second row position of the seventeenth block 17A, the sixth section 106 is disposed on a second column and second row position of the seventeenth block 17A.

Each of the sixth section 106 and the seventh section 107 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the sixth section 106 and the seventh section 107 in the seventeenth embodiment is the same as that in the above embodiments.

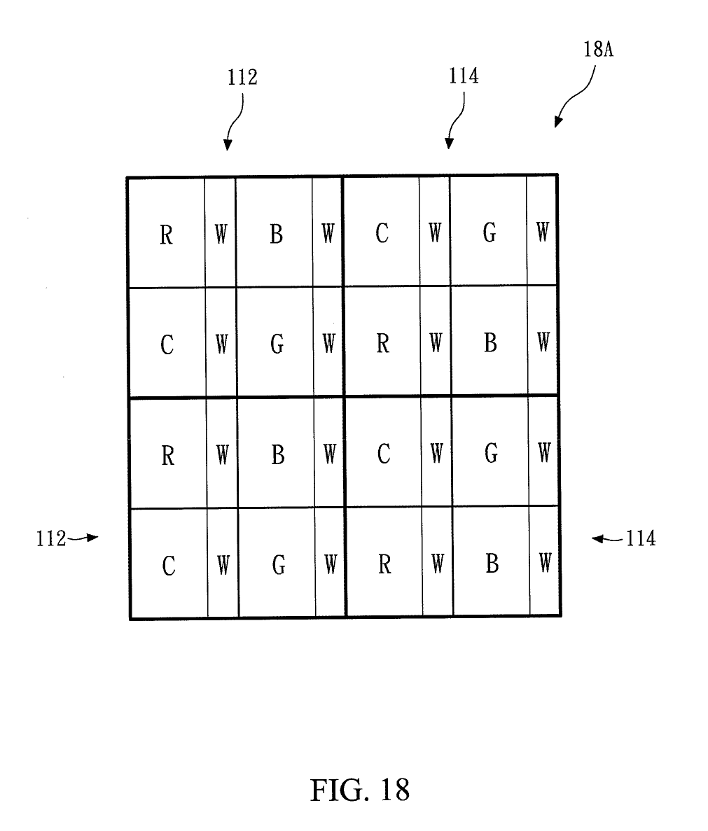

Referring to FIG. 18, it shows the image device according to an eighteenth embodiment of the invention. The image device comprises a plurality of eighteenth blocks 18A. Each eighteenth block 18A comprises two twelfth sections 112 and two fourteenth sections 114. The twelfth section 112 is disposed on a first column and first row position of the eighteenth block 18A, the fourteenth section 114 is disposed on a second column and first row position of the eighteenth block 18A, the twelfth section 112 is disposed on a first column and second row position of the eighteenth block 18A, the fourteenth section 114 is disposed on a second column and second row position of the eighteenth block 18A.

Each of the twelfth section 112 and the fourteenth section 114 comprises the first pixel group 51, the second pixel group 52, the third pixel group 53 and the fourth pixel group 54. The arrangement of the first pixel group 51, the second pixel group 52, the third pixel group 53 and the fourth pixel group 54 in the twelfth section 112 and the fourteenth section 114 in the eighteenth embodiment is the same as that in the above embodiments.

While embodiments of the present invention has been illustrated and described, various modifications and improvements can be made by those skilled in the art. The embodiments of the present invention are therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. An image device, comprising:
a plurality of sections, each section comprising a plurality of pixel groups arranged in a first predetermined identical matrix form, each pixel group comprising a plurality of dots arranged in a second predetermined identical matrix form, each section having a first pixel group, a second pixel group, a third pixel group and a fourth pixel group, wherein the first pixel group comprises at least one first color dot and a second color dot, the second pixel group comprises at least one third color dot and the second color dot, the third pixel group comprises at least one fourth color dot and the second color dot, the fourth pixel group comprises at least one fifth color dot and the second color dot; any four adjacent the first pixel group, the second pixel group, the third pixel group and the fourth pixel group arranged in a 2×2 matrix result in an unbalanced white.

2. The image device according to claim 1, wherein the first color dot is a red color dot, the second color dot is a white color dot, the third color dot is a green color dot and the fourth color dot is a blue color dot.

3. The image device according to claim 2, wherein the first pixel group comprises one first color dot and one second color dot, an area of the first color dot is bigger than that of the second color dot; the second pixel group comprises one third color dot and one second color dot, an area of the third color dot is bigger than that of the second color dot; the third pixel group comprises one fourth color dot and one second color dot, an area of the fourth color dot is bigger than that of the second color dot; and the fourth pixel group comprises one fifth color dot and one second color dot, an area of the fifth color dot is bigger than that of the second color dot, and the fifth color dot is a cyan color dot.

4. The image device according to claim 3, wherein the image device comprises a plurality of first blocks, each first block comprises a first section, a second section, a third section and a fourth section, the first section is disposed on a first column and first row position of the first block, the second section is disposed on a second column and first row position of the first block, the third section is disposed on a first column and second row position of the first block, the fourth section is disposed on a second column and second row position of the first block; each of the first section, the second section, the third section and the fourth section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the second pixel group is disposed on a first column and first row position of the third section, the first pixel group is disposed on a second column and first row position of the third section, the fourth pixel group is disposed on a first column and second row position of the third section, the third pixel group is disposed on a second column and second row position of the third section; the fourth pixel group is disposed on a first column and first row position of the fourth section, the third pixel group is disposed on a second column and first row position of the fourth section, the second pixel group is disposed on a first column and second row position of the fourth section, the first pixel group is disposed on a second column and second row position of the fourth section.

5. The image device according to claim 3, wherein the image device comprises a plurality of second blocks, each second block comprises a first section, a third section, a fifth section and a sixth section, the first section is disposed on a first column and first row position of the second block, the fifth section is disposed on a second column and first row position of the second block, the third section is disposed on a first column and second row position of the second block, the sixth section is disposed on a second column and second row position of the second block; each of the first section, the third section, the fifth section and the sixth section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the second pixel group is disposed on a first column and first row position of the third section, the first pixel group is disposed on a second column and first row position of the third section, the fourth pixel group is disposed on a first column and second row position of the third section, the third pixel group is disposed on a second column and second row position of the third section; the fourth pixel group is disposed on a first column and first row position of the sixth section, the third pixel group is disposed on a second column and first row position of the sixth section, the first pixel group is disposed on a first column and second row position of the sixth section, the second pixel group is disposed on a second column and second row position of the sixth section.

6. The image device according to claim 3, wherein the image device comprises a plurality of third blocks, each third block comprises a second section, a fourth section, a seventh section and an eighth section, the seventh section is disposed on a first column and first row position of the third block, the second section is disposed on a second column and first row position of the third block, the eighth section is disposed on a first column and second row position of the third block, the fourth section is disposed on a second column and second row position of the third block; each of the second section, the fourth section, the seventh section and the eighth section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the second pixel group is disposed on a first column and first row position of the eighth section, the first pixel group is disposed on a second column and first row position of the eighth section, the third pixel group is disposed on a first column and second row position of the eighth section, the fourth pixel group is disposed on a second column and second row position of the eighth section; the fourth pixel group is disposed on a first column and first row position of the fourth section, the third pixel group is disposed on a second column and first row position of the fourth section, the second pixel group is disposed on a first column and second row position of the fourth section, the first pixel group is disposed on a second column and second row position of the fourth section.

7. The image device according to claim 3, wherein the image device comprises a plurality of fourth blocks, each fourth block comprises a fifth section, a sixth section, a seventh section and an eighth section, the seventh section is disposed on a first column and first row position of the fourth block, the fifth section is disposed on a second column and first row position of the fourth block, the eighth section is disposed on a first column and second row position of the fourth block, the sixth section is disposed on a second column and second row position of the fourth block; each of the fifth section, the sixth section, the seventh section and the eighth section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the second pixel group is disposed on a first column and first row position of the eighth section, the first pixel group is disposed on a second column and first row position of the eighth section, the third pixel group is disposed on a first column and second row position of the eighth section, the fourth pixel group is disposed on a second column and second row position of the eighth section; the fourth pixel group is disposed on a first column and first row position of the sixth section, the third pixel group is disposed on a second column and first row position of the sixth section, the first pixel group is disposed on a first column and second row position of the sixth section, the second pixel group is disposed on a second column and second row position of the sixth section.

8. The image device according to claim 3, wherein the image device comprises a plurality of fifth blocks, each fifth block comprises a first section, a second section, a ninth section and a tenth section, the first section is disposed on a first column and first row position of the fifth block, the second section is disposed on a second column and first row position of the fifth block, the ninth section is disposed on a first column and second row position of the fifth block, the tenth section is disposed on a second column and second row position of the fifth block; each of the first section, the second section, the ninth section and the tenth section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the second pixel group is disposed on a first column and first row position of the ninth section, the third pixel group is disposed on a second column and first row position of the ninth section, the fourth pixel group is disposed on a first column and second row position of the ninth section, the first pixel group is disposed on a second column and second row position of the ninth section; the fourth pixel group is disposed on a first column and first row position of the tenth section, the first pixel group is disposed on a second column and first row position of the tenth section, the second pixel group is disposed on a first column and second row position of the tenth section, the third pixel group is disposed on a second column and second row position of the tenth section.

9. The image device according to claim 3, wherein the image device comprises a plurality of sixth blocks, each sixth block comprises a fifth section, a seventh section, an eleventh section and a twelfth section, the seventh section is disposed on a first column and first row position of the sixth block, the fifth section is disposed on a second column and first row position of the sixth block, the eleventh section is disposed on a first column and second row position of the sixth block, the twelfth section is disposed on a second column and second row position of the sixth block; each of the fifth section, the seventh section, the eleventh section and the twelfth section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the second pixel group is disposed on a first column and first row position of the eleventh section, the fourth pixel group is disposed on a second column and first row position of the eleventh section, the third pixel group is disposed on a first column and second row position of the eleventh section, the first pixel group is disposed on a second column and second row position of the eleventh section; the first pixel group is disposed on a first column and first row position of the twelfth section, the third pixel group is disposed on a second column and first row position of the twelfth section, the fourth pixel group is disposed on a first column and second row position of the twelfth section, the second pixel group is disposed on a second column and second row position of the twelfth section.

10. The image device according to claim 3, wherein the image device comprises a plurality of seventh blocks, each seventh block comprises a first section, a second section, a third section and a fourth section, the first section is disposed on a first column and first row position of the seventh block, the second section is disposed on a second column and first row position of the seventh block, the fourth section is disposed on a first column and second row position of the seventh block, the third section is disposed on a second column and second row position of the seventh block; each of the first section, the second section, the third section and the fourth section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the second pixel group is disposed on a first column and first row position of the third section, the first pixel group is disposed on a second column and first row position of the third section, the fourth pixel group is disposed on a first column and second row position of the third section, the third pixel group is disposed on a second column and second row position of the third section; the fourth pixel group is disposed on a first column and first row position of the fourth section, the third pixel group is disposed on a second column and first row position of the fourth section, the second pixel group is disposed on a first column and second row position of the fourth section, the first pixel group is disposed on a second column and second row position of the fourth section.

11. The image device according to claim 3, wherein the image device comprises a plurality of eighth blocks, each eighth block comprises a first section, a fourth section, a fifth section and a seventh section, the first section is disposed on a first column and first row position of the eighth block, the fifth section is disposed on a second column and first row position of the eighth block, the fourth section is disposed on a first column and second row position of the eighth block, the seventh section is disposed on a second column and second row position of the eighth block; each of the first section, the fourth section, the fifth section and the seventh section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the fourth pixel group is disposed on a first column and first row position of the fourth section, the third pixel group is disposed on a second column and first row position of the fourth section, the second pixel group is disposed on a first column and second row position of the fourth section, the first pixel group is disposed on a second column and second row position of the fourth section; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section.

12. The image device according to claim 3, wherein the image device comprises a plurality of ninth blocks, each ninth block comprises a second section, a third section, a fifth section and a seventh section, the seventh section is disposed on a first column and first row position of the ninth block, the second section is disposed on a second column and first row position of the ninth block, the fifth section is disposed on a first column and second row position of the ninth block, the third section is disposed on a second column and second row position of the ninth block; each of the second section, the third section, the fifth section and the seventh section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the second pixel group is disposed on a first column and first row position of the third section, the first pixel group is disposed on a second column and first row position of the third section, the fourth pixel group is disposed on a first column and second row position of the third section, the third pixel group is disposed on a second column and second row position of the third section.

13. The image device according to claim 3, wherein the image device comprises a plurality of tenth blocks, each tenth block comprises two fifth sections and two seventh sections, the seventh section is disposed on a first column and first row position of the tenth block, the fifth section is disposed on a second column and first row position of the tenth block, the fifth section is disposed on a first column and second row position of the tenth block, the seventh section is disposed on a second column and second row position of the tenth block; each of the fifth section and the seventh section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section.

14. The image device according to claim 3, wherein the image device comprises a plurality of eleventh blocks, each eleventh block comprises a first section, a second section, a ninth section and a tenth section, the first section is disposed on a first column and first row position of the eleventh block, the second section is disposed on a second column and first row position of the eleventh block, the tenth section is disposed on a first column and second row position of the eleventh block, the ninth section is disposed on a second column and second row position of the eleventh block; each of the first section, the second section, the ninth section and the tenth section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section; the second pixel group is disposed on a first column and first row position of the ninth section, the third pixel group is disposed on a second column and first row position of the ninth section, the fourth pixel group is disposed on a first column and second row position of the ninth section, the first pixel group is disposed on a second column and second row position of the ninth section; the fourth pixel group is disposed on a first column and first row position of the tenth section, the first pixel group is disposed on a second column and first row position of the tenth section, the second pixel group is disposed on a first column and second row position of the tenth section, the third pixel group is disposed on a second column and second row position of the tenth section.

15. The image device according to claim 3, wherein the image device comprises a plurality of twelfth blocks, each twelfth block comprises a fifth section, a seventh section, a thirteenth section and a fourteenth section, the seventh section is disposed on a first column and first row position of the twelfth block, the fifth section is disposed on a second column and first row position of the twelfth block, the thirteenth section is disposed on a first column and second row position of the twelfth block, the fourteenth section is disposed on a second column and second row position of the twelfth block; each of the fifth section, the seventh section, the thirteenth section and the fourteenth section comprises the first pixel group, the second pixel group, the third pixel group and the fourth pixel group; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section; the third pixel group is disposed on a first column and first row position of the fifth section, the fourth pixel group is disposed on a second column and first row position of the fifth section, the second pixel group is disposed on a first column and second row position of the fifth section, the first pixel group is disposed on a second column and second row position of the fifth section; the third pixel group is disposed on a first column and first row position of the thirteenth section, the first pixel group is disposed on a second column and first row position of the thirteenth section, the second pixel group is disposed on a first column and second row position of the thirteenth section, the fourth pixel group is disposed on a second column and second row position of the thirteenth section; the fourth pixel group is disposed on a first column and first row position of the fourteenth section, the second pixel group is disposed on a second column and first row position of the fourteenth section, the first pixel group is disposed on a first column and second row position of the fourteenth section, the third pixel group is disposed on a second column and second row position of the fourteenth section.

16. The image device according to claim 3, wherein the image device comprises a plurality of thirteenth blocks, each thirteenth block comprises two first sections and two second sections, the first section is disposed on a first column and first row position of the thirteenth block, the second section is disposed on a second column and first row position of the thirteenth block, the first section is disposed on a first column and second row position of the thirteenth block, the second section is disposed on a second column and second row position of the thirteenth block; each of the first section and the second section comprises the first pixel group, the second pixel group, the third pixel group and the fourth pixel group; the first pixel group is disposed on a first column and first row position of the first section, the second pixel group is disposed on a second column and first row position of the first section, the third pixel group is disposed on a first column and second row position of the first section, the fourth pixel group is disposed on a second column and second row position of the first section; the third pixel group is disposed on a first column and first row position of the second section, the fourth pixel group is disposed on a second column and first row position of the second section, the first pixel group is disposed on a first column and second row position of the second section, the second pixel group is disposed on a second column and second row position of the second section.

17. The image device according to claim 3, wherein the image device comprises a plurality of fourteenth blocks, each fourteenth block comprises two fifteenth sections and two sixteenth sections, the fifteenth section is disposed on a first column and first row position of the fourteenth block, the sixteenth section is disposed on a second column and first row position of the fourteenth block, the fifteenth section is disposed on a first column and second row position of the fourteenth block, the sixteenth section is disposed on a second column and second row position of the fourteenth block; each of the fifteenth section and the sixteenth section comprises the first pixel group, the second pixel group, the third pixel group and the fourth pixel group; the first pixel group is disposed on a first column and first row position of the fifteenth section, the fourth pixel group is disposed on a second column and first row position of the fifteenth section, the third pixel group is disposed on a first column and second row position of the fifteenth section, the second pixel group is disposed on a second column and second row position of the fifteenth section; the third pixel group is disposed on a first column and first row position of the sixteenth section, the second pixel group is disposed on a second column and first row position of the sixteenth section, the first pixel group is disposed on a first column and second row position of the sixteenth section, the fourth pixel group is disposed on a second column and second row position of the sixteenth section.

18. The image device according to claim 3, wherein the image device comprises a plurality of fifteenth blocks, each fifteenth block comprises two seventeenth sections and two eighteenth sections, the seventeenth section is disposed on a first column and first row position of the fifteenth block, the eighteenth section is disposed on a second column and first row position of the fifteenth block, the seventeenth section is disposed on a first column and second row position of the fifteenth block, the eighteenth section is disposed on a second column and second row position of the fifteenth block; each of the seventeenth section and the eighteenth section comprises the first pixel group, the second pixel group, the third pixel group and the fourth pixel group; the first pixel group is disposed on a first column and first row position of the seventeenth section, the third pixel group is disposed on a second column and first row position of the seventeenth section, the second pixel group is disposed on a first column and second row position of the seventeenth section, the fourth pixel group is disposed on a second column and second row position of the seventeenth section; the second pixel group is disposed on a first column and first row position of the eighteenth section, the fourth pixel group is disposed on a second column and first row position of the eighteenth section, the first pixel group is disposed on a first column and second row position of the eighteenth section, the third pixel group is disposed on a second column and second row position of the eighteenth section.

19. The image device according to claim 3, wherein the image device comprises a plurality of sixteenth blocks, each sixteenth block comprises two nineteenth sections and two twentieth sections, the nineteenth section is disposed on a first column and first row position of the sixteenth block, the twentieth section is disposed on a second column and first row position of the sixteenth block, the nineteenth section is disposed on a first column and second row position of the sixteenth block, the twentieth section is disposed on a second column and second row position of the sixteenth block; each of the nineteenth section and the twentieth section comprises the first pixel group, the second pixel group, the third pixel group and the fourth pixel group; the first pixel group is disposed on a first column and first row position of the nineteenth section, the fourth pixel group is disposed on a second column and first row position of the nineteenth section, the second pixel group is disposed on a first column and second row position of the nineteenth section, the third pixel group is disposed on a second column and second row position of the nineteenth section; the second pixel group is disposed on a first column and first row position of the twentieth section, the third pixel group is disposed on a second column and first row position of the twentieth section, the first pixel group is disposed on a first column and second row position of the twentieth section, the fourth pixel group is disposed on a second column and second row position of the twentieth section.

20. The image device according to claim 3, wherein the image device comprises a plurality of seventeenth blocks, each seventeenth block comprises two sixth sections and two seventh sections, the seventh section is disposed on a first column and first row position of the seventeenth block, the sixth section is disposed on a second column and first row position of the seventeenth block, the seventh section is disposed on a first column and second row position of the seventeenth block, the sixth section is disposed on a second column and second row position of the seventeenth block; each of the sixth section and the seventh section comprises the first pixel group, the second pixel group, the third pixel group and the fourth pixel group; the fourth pixel group is disposed on a first column and first row position of the sixth section, the third pixel group is disposed on a second column and first row position of the sixth section, the first pixel group is disposed on a first column and second row position of the sixth section, the second pixel group is disposed on a second column and second row position of the sixth section; the first pixel group is disposed on a first column and first row position of the seventh section, the second pixel group is disposed on a second column and first row position of the seventh section, the fourth pixel group is disposed on a first column and second row position of the seventh section, the third pixel group is disposed on a second column and second row position of the seventh section.

21. The image device according to claim 3, wherein the image device comprises a plurality of eighteenth blocks, each eighteenth block comprises two twelfth sections and two fourteenth sections, the twelfth section is disposed on a first column and first row position of the eighteenth block, the fourteenth section is disposed on a second column and first row position of the eighteenth block, the twelfth section is disposed on a first column and second row position of the eighteenth block, the fourteenth section is disposed on a second column and second row position of the eighteenth block; each of the twelfth section and the fourteenth section comprises the first pixel group, the second pixel group, the third pixel group and the fourth pixel group; the first pixel group is disposed on a first column and first row position of the twelfth section, the third pixel group is disposed on a second column and first row position of the twelfth section, the fourth pixel group is disposed on a first column and second row position of the twelfth section, the second pixel group is disposed on a second column and second row position of the twelfth section; the fourth pixel group is disposed on a first column and first row position of the fourteenth section, the second pixel group is disposed on a second column and first row position of the fourteenth section, the first pixel group is disposed on a first column and second row position of the fourteenth section, the third pixel group is disposed on a second column and second row position of the fourteenth section.
